(19) United States
(12) Patent Application Publication
(10) Pub. No.: US 2025/0023499 A1
(43) Pub. Date: Jan. 16, 2025

(54) DRIVE UNIT

(71) Applicant: EXEDY Corporation, Neyagawa-shi (JP)

(72) Inventor: Yoshihiro MATSUOKA, Neyagawa-shi (JP)

(21) Appl. No.: 18/743,921

(22) Filed: Jun. 14, 2024

(30) Foreign Application Priority Data
Jul. 12, 2023 (JP) 2023-114731

(51) Int. Cl. H02P 23/30; H02P 25/022

(52) U.S. Cl. CPC H02P 23/30; H02P 25/022

(57) ABSTRACT

It is intended to provide a drive unit enabled to easily generate a creep torque. The present drive unit includes an electric motor, a torque converter, and a controller. The electric motor functions as a drive source of the drive unit. The torque converter is configured to amplify a torque outputted from the electric motor. The controller controls the electric motor such that the electric motor is rotated at a constant rotational speed to output a creep torque.

### CROSS-REFERENCE TO RELATED APPLICATIONS

This application is based on and claims the priority benefit of Japanese application 2023-114731 filed on Jul. 12, 2023, the contents of which are incorporated herein by reference.

### TECHNICAL FIELD

The present invention relates to a drive unit.

### BACKGROUND

There has been proposed a type of electric vehicle by which creep traveling is enabled. For example, an electric vehicle described in Publication of Japan Patent No. 3440757 includes a motor torque control device. The motor torque control device is configured to cause a motor to generate a torque when neither an accelerator pedal nor a brake pedal are being operated. Specifically, the motor torque control device gradually increases a creep torque, while controlling a gain by a vehicle speed. In addition, the motor torque control device controls a gain increase rate in accordance with a hill-climbing resistance. With this configuration, physical shock is inhibited from acting on occupants of the electric vehicle, whereby riding comfortableness of the occupants is improved in the electric vehicle.

### SUMMARY OF THE INVENTION

The motor torque control device configured as described above executes complicated torque computations to generate a creep torque and is therefore complicated in configuration. In view of the above, it is an object of the present invention to provide a drive unit enabled to easily generate a creep torque.

A drive unit according to a first aspect includes an electric motor, a torque converter, and a controller. The electric motor functions as a drive source. The torque converter is configured to amplify a torque outputted from the electric motor. The controller controls the electric motor such that the electric motor is rotated at a constant rotational speed to output a creep torque.

According to the configuration, when controlling and causing the electric motor to output the creep torque, the controller simply causes the electric motor to rotate at the constant rotational speed without executing complicated control such as torque computations. Therefore, the drive unit described above can easily generate the creep torque. The drive unit outputs the torque through the torque converter. Therefore, when a load acting on a drive wheel is large in magnitude, the torque outputted from the torque converter is increased in magnitude as well; on the other hand, when the torque acting on the drive wheel is small in magnitude, the torque outputted from the torque converter is relatively reduced in magnitude as well. Because of this, smooth creep traveling is enabled.

A drive unit according to a second aspect relates to the drive unit according to the first aspect and further includes a first switch operable by a driver. The controller controls the electric motor such that the electric motor is rotated at a first rotational speed to output the creep torque when an acceleration operation has not been performed and the first switch has been turned on.

A drive unit according to a third aspect relates to the drive unit according to the second aspect and is configured as follows. The first rotational speed is set such that a first torque, calculated based on a capacity coefficient of the torque converter and the first rotational speed, is less than or equal to a rated torque of the electric motor.

A drive unit according to a fourth aspect relates to the drive unit according to the second or third aspect, and the first rotational speed is less than or equal to a base rotational speed of the electric motor.

A drive unit according to a fifth aspect relates to the drive unit according to any of the second to fourth aspects, and further includes a second switch operable by the driver. The controller controls the electric motor such that the electric motor is rotated at a second rotational speed to output the creep torque when the acceleration operation has not been performed, the first switch has been turned on, and the second switch has been turned on.

A drive unit according to a sixth aspect relates to the drive unit according to the fifth aspect, and the second rotational speed is higher than the first rotational speed.

A drive unit according to a seventh aspect relates to the drive unit according to the fifth or sixth aspect and is configured as follows. The second rotational speed is set such that a second torque, calculated based on a capacity coefficient of the torque converter and the second rotational speed, is greater than or equal to a rated torque of the electric motor and less than or equal to a maximum torque of the electric motor.

A drive unit according to an eighth aspect relates to the drive unit according to any of the fifth to seventh aspects, and the second rotational speed is less than or equal to a base rotational speed of the electric motor.

A drive unit according to a ninth aspect relates to the drive unit according to any of the fifth to eighth aspects and is configured as follows. The controller controls the electric motor such that the electric motor is rotated at the first rotational speed or less when at least either a temperature of the electric motor or a temperature of a hydraulic fluid in the torque converter is greater than a threshold after determining that the acceleration operation has not been performed, the first switch has been turned on, and the second switch has been turned on. It should be noted that “the temperature of the electric motor” is conceptualized as encompassing not only the temperature of the electric motor per se but also the temperature of an inverter for controlling the electric motor.

Overall, according to the present invention, it is made possible to easily generate a creep torque.

### BRIEF DESCRIPTION OF THE DRAWINGS

FIG. 1 is a schematic diagram of a drive unit.

FIG. 2 is a perspective view of a shift lever.

FIG. 3 is a chart showing characteristics of an electric motor and a torque converter.

FIG. 4 is a flowchart showing a method of controlling by a controller.

### DETAILED DESCRIPTION

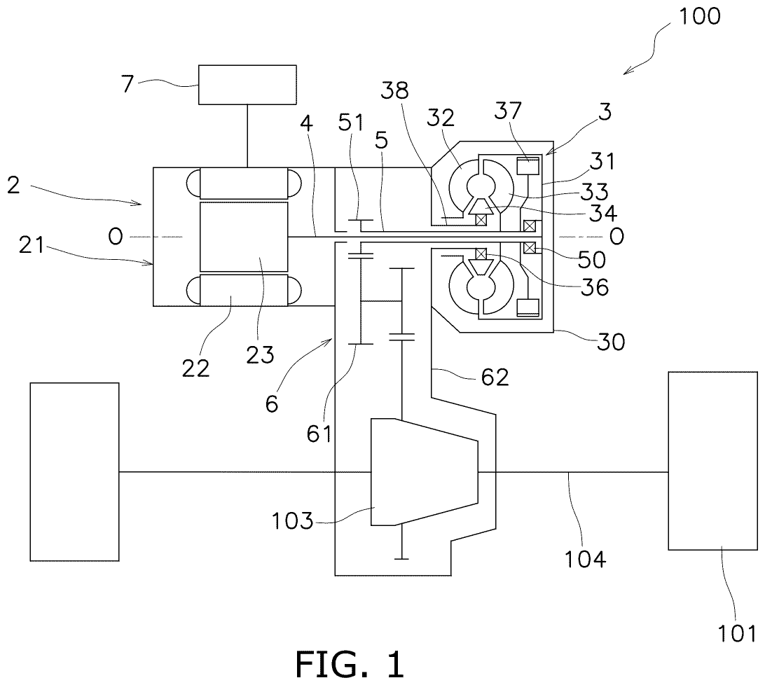

A preferred embodiment of a drive unit will be hereinafter explained with reference to drawings. FIG. 1 is a schematic diagram of the drive unit according to the present preferred embodiment. It should be noted that in the following explanation, the term “axial direction” refers to an extending direction of a rotational axis O for an electric motor 2 or that for a torque converter 3. On the other hand, the term “circumferential direction” refers to a circumferential direction of an imaginary circle about the rotational axis O, whereas the term “radial direction” refers to a radial direction of the imaginary circle about the rotational axis O. Moreover, the term “forward rotation” refers to rotation in forward movement of a vehicle, whereas the term “reverse rotation” refers to rotation in rearward movement of the vehicle.

### [Drive Unit 100]

As shown in FIG. 1, a drive unit 100 includes the electric motor 2, the torque converter 3, a first drive shaft 4, a second drive shaft 5, a reducer 6, and a controller 7. The drive unit 100 is installed in, for instance, an electric vehicle. The drive unit 100 is configured to drive the drive wheels 101.

### <Electric Motor>

The electric motor 2 functions as a drive source of the drive unit 100. The electric motor 2 is a synchronous alternating-current motor. It should be noted that the drive unit 100 includes the electric motor 2 as the only drive source thereof. In other words, the drive unit 100 does not include an internal combustion engine as a drive source. In the present preferred embodiment, the drive unit 100 does not include an internal combustion engine as a drive source but may include an internal combustion engine to be used for generating electricity.

The electric motor 2 includes a motor casing 21, a motor stator 22, and a rotor 23. In the present preferred embodiment, the electric motor 2 is of a so-called inner rotor type. The electric motor 2 includes an inverter (omitted in illustration) for controlling the rotational speed of the electric motor 2.

The motor casing 21 is non-rotatable, while being fixed to a body frame of the vehicle. The motor casing 21 accommodates the motor stator 22 and the rotor 23 in the interior thereof.

The motor stator 22 is fixed to the inner peripheral surface of the motor casing 21. The motor stator 22 is non-rotatable. The rotor 23 is rotated about the rotational axis O. The rotor 23 is disposed radially inside the motor stator 22. The motor stator 22 is disposed radially away from the rotor 23 at an interval.

### <Torque Converter>

The torque converter 3 is disposed away from the electric motor 2 at an interval in the axial direction. The reducer 6 is disposed between the torque converter 3 and the electric motor 2. The electric motor 2, the reducer 6, and the torque converter 3 are aligned in this order in the axial direction.

The torque converter 3 is disposed to be rotatable. The rotational axis O of the torque converter 3 is substantially matched with that of the electric motor 2. The torque converter 3 is a device to which a torque, outputted from the electric motor 2, is transmitted. The torque converter 3 is configured to amplify the torque outputted from the electric motor 2.

Moreover, the torque converter 3 includes a cover 31, an impeller 32, a turbine 33, a stator 34, a first one-way clutch 36, and a lock-up clutch 37. In the present preferred embodiment, the outer shell of the torque converter 3 is composed of the cover 31 and the impeller 32. Hydraulic fluid is supplied to the interior of the torque converter 3. The hydraulic fluid is, for instance, hydraulic oil.

The torque converter 3 is configured such that the impeller 32 is disposed on the electric motor 2 side (the left side in FIG. 1), whereas the cover 31 is disposed on the opposite side of the electric motor 2 (the right side in FIG. 1). The torque converter 3 is accommodated in the interior of the torque converter casing 30.

The cover 31 is a component to which the torque, transmitted from the electric motor 2, is inputted. The cover 31 is rotated by the torque transmitted thereto from the electric motor 2. The cover 31 is fixed to the first drive shaft 4. For example, the cover 31 includes a spline hole to which the first drive shaft 4 is spline-coupled. Because of this, the cover 31 is unitarily rotated with the first drive shaft 4. The cover 31 is disposed to cover the turbine 33.

The impeller 32 is unitarily rotated with the cover 31. The impeller 32 is a component to which the torque, transmitted from the electric motor 2, is inputted through the cover 31. The impeller 32 is fixed to the cover 31. The impeller 32 is rotatably supported by a stationary shaft 38 through a bearing member (omitted in illustration). It should be noted that the stationary shaft 38 has a cylindrical shape. The impeller 32 and the stationary shaft 38 are airtightly sealed therebetween. The second drive shaft 5 extends through the interior of the stationary shaft 38 in the axial direction. Besides, the stationary shaft 38 extends from, for instance, either a reducer casing 62 or the torque converter casing 30. The stationary shaft 38 is non-rotatable.

The turbine 33 is disposed in opposition to the impeller 32. When described in detail, the turbine 33 is opposed to the impeller 32 in the axial direction. The turbine 33 is a component to which the torque is transmitted from the impeller 32 through the hydraulic fluid.

The second drive shaft 5 is attached to the turbine 33. When described in detail, the second drive shaft 5 is spline-coupled to the turbine 33. The turbine 33 is unitarily rotated with the second drive shaft 5.

The stator 34 is configured to regulate the flow of the hydraulic oil returning from the turbine 33 to the impeller 32. The stator 34 is rotatable about the rotational axis O. For example, the stator 34 is supported by the stationary shaft 38 through the first one-way clutch 36. The stator 34 is disposed between the impeller 32 and the turbine 33 in the axial direction.

The first one-way clutch 36 is disposed between the stationary shaft 38 and the stator 34. The first one-way clutch 36 is configured to make the stator 34 rotatable in a direction of forward rotation. On the other hand, the first one-way clutch 36 makes the stator 34 non-rotatable in a direction of reverse rotation. The torque is transmitted from the impeller 32 to the turbine 33, while being amplified by the stator 34.

When a clutch-on state of the lock-up clutch 37 is made, the impeller 32 and the turbine 33 are directly coupled to each other. On the other hand, when a clutch-off state of the lock-up clutch 37 is made, the impeller 32 and the turbine 33 are released from being directly coupled to each other.

It should be noted that in the present preferred embodiment, the lock-up clutch 37 is attached to either the turbine 33 or the second drive shaft 5. The lock-up clutch 37 is unitarily rotated with the turbine 33. The lock-up clutch 37 is made in the form of a centrifugal clutch. In other words, the lock-up clutch 37 is configured to couple the cover 31 and the turbine 33 to each other by a centrifugal force generated in rotation of the turbine 33. Specifically, the lock-up clutch 37 is configured to transmit the torque from the cover 31 to the turbine 33 when the rotation of the turbine 33 reaches a predetermined speed or greater.

The torque converter 3 is accommodated in the interior of a torque converter casing 30. The torque converter casing 30 is disposed to be non-rotatable. For example, the torque converter casing 30 is fixed to the body frame of the vehicle or so forth.

### <Reducer>

The reducer 6 is disposed between the electric motor 2 and the torque converter 3 in the axial direction. The reducer 6 reduces the speed of rotation of the torque converter 3 and transmits the rotation reduced in speed to the drive wheel 101 side. When described in detail, the reducer 6 reduces the speed of rotation of the second drive shaft 5 and transmits the rotation reduced in speed to the drive wheel 101 side. It should be noted that the reducer 6 includes a plurality of gears 61. The reducer 6 is accommodated in the interior of the reducer casing 62. It should be noted that one of the plural gears 61 is meshed with a gear 51 fixed to the second drive shaft 5.

### <First Drive Shaft>

The first drive shaft 4 extends from the electric motor 2 toward the torque converter 3 in the axial direction. When described in detail, the first drive shaft 4 extends from the rotor 23 of the electric motor 2. It should be noted that when the electric motor 2 includes an output shaft, the first drive shaft 4 is attached to the output shaft of the electric motor 2. The rotational axis of the first drive shaft 4 is substantially matched with that of the electric motor 2 and that of the torque converter 3.

The first drive shaft 4 transmits the torque between the electric motor 2 and the torque converter 3. When described in detail, the first drive shaft 4 transmits the torque, inputted thereto from the electric motor 2, to the torque converter 3. The first drive shaft 4 is connected to the impeller 32 of the torque converter 3. When described in detail, the first drive shaft 4 is connected to the impeller 32 through the cover 31. The first drive shaft 4 is attached at the distal end thereof to the cover 31 of the torque converter 3.

### <Second Drive Shaft>

The second drive shaft 5 transmits the torque between the torque converter 3 and the reducer 6. The second drive shaft 5 transmits the torque, inputted thereto from the torque converter 3, to the drive wheel 101 side. When described in detail, the second drive shaft 5 outputs the torque, inputted thereto from the torque converter 3, to the reducer 6. The second drive shaft 5 extends from the torque converter 3 toward the electric motor 2 in the axial direction.

The second drive shaft 5 has a cylindrical shape. The first drive shaft 4 extends through the interior of the second drive shaft 5. It should be noted that the first drive shaft 4 is solid. The second drive shaft 5 is attached at one end thereof (the right end in FIG. 1) to the turbine 33 of the torque converter 3. On the other hand, the second drive shaft 5 is provided with the gear 51 attached to the other end thereof (the left end in FIG. 1). For example, the second drive shaft 5 is rotatably supported by the reducer casing 62 and/or so forth through a bearing member and/or so forth.

### <Second One-Way Clutch>

The drive unit 100 further includes a second one-way clutch 50. The second one-way clutch 50 is disposed between the first drive shaft 4 and the second drive shaft 5. When described in detail, the second one-way clutch 50 is disposed between the cover 31 and the turbine 33. The second one-way clutch 50 makes the first drive shaft 4 rotatable relative to the second drive shaft 5 in the direction of forward rotation. In other words, the second one-way clutch 50 is configured such that the first drive shaft 4 is rotated relative to the second drive shaft 5 when the electric motor 2 is forwardly rotated to move the vehicle forward. Because of this, in forward movement of the vehicle, the second one-way clutch 50 does not transmit the torque from the first drive shaft 4 to the second drive shaft 5.

By contrast, the second one-way clutch 50 makes the first drive shaft 4 unitarily rotate with the second drive shaft 5 in the direction of reverse rotation. In other words, the second one-way clutch 50 is configured such that the first drive shaft 4 is unitarily rotated with the second drive shaft 5 when the electric motor 2 is reversely rotated to move the vehicle rearward. Because of this, in rearward movement of the vehicle, the second one-way clutch 50 transmits the torque from the first drive shaft 4 to the second drive shaft 5. In other words, in rearward movement of the vehicle, the torque outputted from the electric motor 2 is transmitted from the first drive shaft 4 to the second drive shaft 5 not through the hydraulic fluid in the torque converter 3 but through the second one-way clutch 50.

### <Differential Gear>

The drive unit 100 further includes a differential gear 103 and a pair of drive shafts 104. The differential gear 103 is configured to transmit the torque, inputted thereto from the reducer 6, to the pair of drive wheels 101.

The pair of drive shafts 104 extends from the differential gear 103 to the pair of drive wheels 101, respectively. The pair of drive shafts 104 extends in the axial direction. In other words, the pair of drive shafts 104 extends in parallel to the first and second drive shafts 4 and 5. Besides, the pair of drive shafts 104 extends to be offset (displaced) from the first and second drive shafts 4 and 5.

### <First and Second Switches>

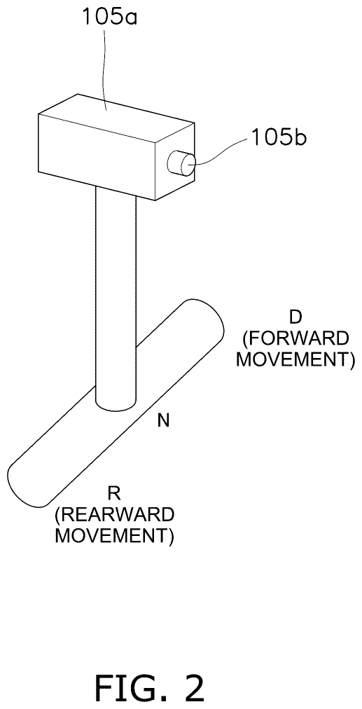

As shown in FIG. 2, the drive unit 100 includes a first switch 105a and a second switch 105b. The first switch 105a is operated by a driver. The first switch 105a is, for instance, a shift lever. A condition that the first switch 105a is turned on means, for instance, a condition that the driver shifts the shift lever to a D (drive) position from a position other than the D position (e.g., an N (neutral) position). Thus, in the present preferred embodiment, the condition that the first switch 105a is turned on refers to a condition that forward movement of the vehicle is enabled if the operator/deriver performs an acceleration operation. On the other hand, when the shift lever is shifted from the D position to any of the other positions, the first switch 105a is turned off.

The second switch 105b is provided on, for instance, the shift lever. The second switch 105b is operated by the driver. For example, the second switch 105b is a pushbutton switch. The second switch 105b may be of a momentary type. Specifically, when the driver pushes the second switch 105b, the second switch 105b is switched on; on the other hand, when the driver releases the second switch 105b, the second switch 105b is switched off. Alternatively, the second switch 105b may be of an alternate type. Specifically, when the driver pushes the second switch 105b, the second switch 105 is switched on; furthermore, when the driver pushes the second switch 105b again, the second switch 105b is switched off.

### <Controller>

The controller 7 is configured to control the electric motor 2 such that the electric motor 2 is rotated at a constant rotational speed to output a creep torque. When the electric motor 2 is thus rotated at the constant rotational speed to output the creep torque, this results in creep traveling of the vehicle that the drive unit 100 is installed. For example, a computer (e.g., microcomputer), including a CPU (Central Processing Unit), a ROM (Read Only Memory), and so forth, is provided as the controller 7. The ROM stores programs for various computations. The CPU executes the programs stored in the ROM.

The controller 7 is configured to execute a first creep mode and a second creep mode. The controller 7 executes the first creep mode if it is determined that the acceleration operation has not been performed and the first switch 105a has been turned on. In the first creep mode, the controller 7 controls the electric motor 2 such that the electric motor 2 is rotated at a first rotational speed to output the creep torque.

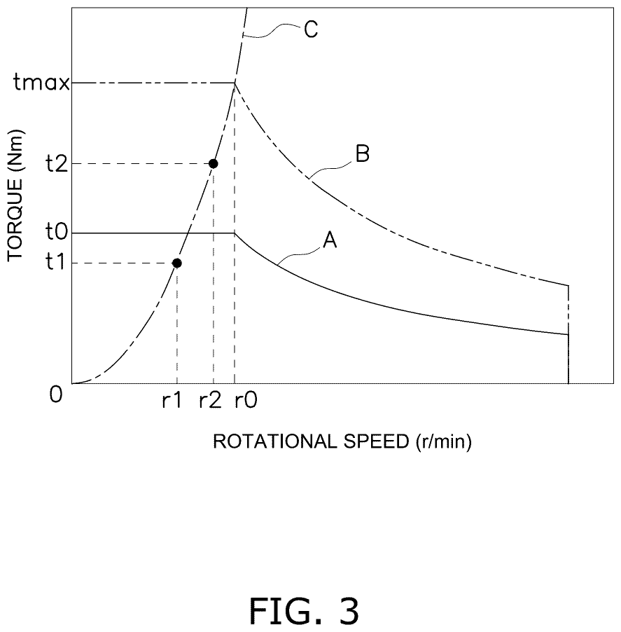

FIG. 3 is a chart showing a characteristic of the electric motor 2 and that of the torque converter 3. A solid line in FIG. 3 is a characteristic line A indicating a relation between the rotational speed of the electric motor 2 and a rated torque of the electric motor 2. A dashed two-dotted line in FIG. 3 is a characteristic line B indicating a relation between the rotational speed of the electric motor 2 and a maximum torque of the electric motor 2. A dashed-dotted line in FIG. 3 is a characteristic line C indicating a relation between an input rotational speed and an input torque based on a capacity coefficient of the torque converter 3. Here, the electric motor 2 is coupled to an input part (the impeller 32) of the torque converter 3; hence, the relation between the rotational speed of the electric motor 2 and the torque of the electric motor 2 is also indicated by the characteristic line C. Because of this, the torque of the electric motor 2 can be calculated with the characteristic line C and the rotational speed of the electric motor 2.

A first rotational speed is set such that a first torque, calculated based on the capacity coefficient of the torque converter 3 and the first rotational speed, is less than or equal to the rated torque of the electric motor 2. In other words, the first rotational speed is set such that the first torque, calculated based on the characteristic line C and the first rotational speed of the electric motor 2, is less than or equal to the rated torque of the electric motor 2.

Specifically, as shown in FIG. 3, the first torque (t1) at the first rotational speed (r1) of the electric motor 2 is calculated based on the characteristic line C. Then, the first rotational speed (r1) is set such that the first torque (t1) is less than or equal to the rated torque (to) of the electric motor 2. In other words, the first rotational speed (r1) is set to be less than or equal to a rotational speed obtained on an intersection between the characteristic line C and the characteristic line A. It should be noted that the first rotational speed (r1) is set to be less than or equal to a base rotational speed (r0) of the electric motor 2.

The controller 7 executes the second creep mode if it is determined that the acceleration operation has not been performed, the first switch 105a has been turned on, and the second switch 105b has been switched on. In the second creep mode, the controller 7 controls the electric motor 2 such that the electric motor 2 is rotated at a second rotational speed to output the creep torque. It should be noted that the second rotational speed (r2) is higher than the first rotational speed (r1). For example, when the vehicle travels on a hill or so forth, the driver switches on the second switch 105b to execute the second creep mode.

The second rotational speed is set such that a second torque, calculated based on the capacity coefficient of the torque converter 3 and the second rotational speed, is greater than or equal to the rated torque of the electric motor 2 and less than or equal to the maximum torque of the electric motor 2. In other words, the second rotational speed is set such that the second torque, calculated based on the characteristic line C and the second rotational speed of the electric motor 2, is greater than or equal to the rated torque of the electric motor 2 and less than or equal to the maximum torque of the electric motor 2. Specifically, as shown in FIG. 3, the second torque (t2) at the second rotational speed (r2) of the electric motor 2 is calculated based on the characteristic line C. Then, the second rotational speed (r2) is set such that the second torque (t2) is greater than or equal to the rated torque (to) of the electric motor 2 and less than or equal to the maximum torque (tmax) of the electric motor 2. In other words, the second rotational speed (r2) is set to be greater than or equal to the rotational speed obtained on the intersection between the characteristic line C and the characteristic line A and less than or equal to a rotational speed obtained on an intersection between the characteristic line C and the characteristic line B. It should be noted that the second rotational speed (r2) is set to be less than or equal to the base rotational speed (r0) of the electric motor 2.

The controller 7 determines whether at least either the temperature of the electric motor 2 or that of the hydraulic fluid in the torque converter 3 is less than or equal to a threshold. Specifically, the controller 7 obtains, as the temperature of the electric motor 2, the temperature of the body of the electric motor 2 and that of the inverter from temperature sensors. Additionally, the controller 7 obtains the temperature of the hydraulic fluid in the torque converter 3 from another temperature sensor. Then, if it is determined that at least either of the obtained temperatures, i.e., the temperature of the electric motor 2 or that of the hydraulic fluid, is greater than the threshold, the controller 7 controls the electric motor 2 such that the electric motor 2 is rotated at the first rotational speed or less. It should be noted that the threshold for the temperature of the electric motor 2 and that for the temperature of the hydraulic fluid may be identical to or different from each other.

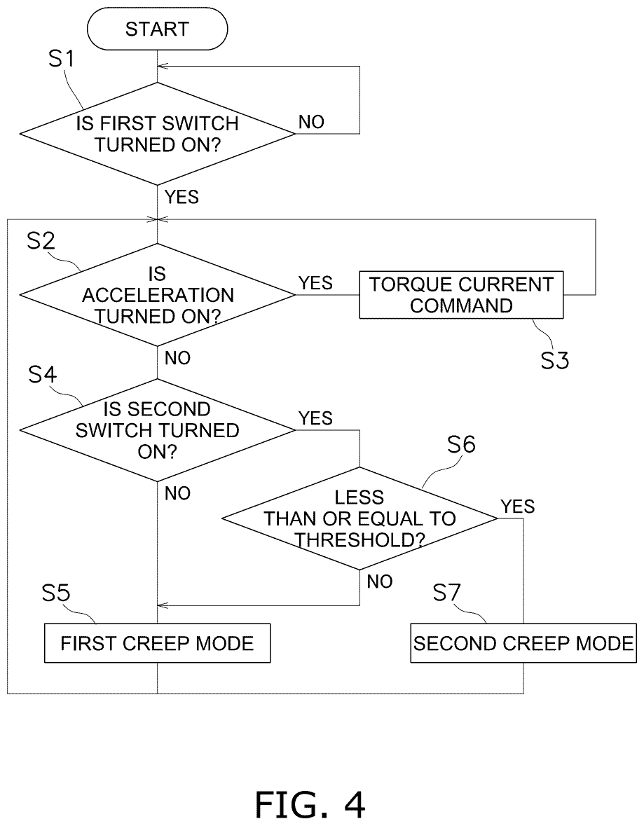

FIG. 4 is a flowchart exemplifying a method of controlling by the controller 7. The method of controlling by the controller 7 will be hereinafter explained with reference to FIG. 4.

The controller 7 determines whether the first switch 105a has been turned on (step S1). If it is determined that the first switch 105a has been turned on (Yes in step S1), the controller 7 next determines whether the acceleration operation has been performed (step S2).

If it is determined that the acceleration operation has been performed (Yes in step S2), the controller 7 issues a torque current command (step S3). Specifically, the controller 7 computes a torque based on the operating amount of the acceleration operation and/or so forth and issues a command of electric current flowing through the electric motor 2 such that the computed torque is outputted from the electric motor 2. Accordingly, normal traveling is performed by the vehicle.

On the other hand, if it is determined that the acceleration operation has not been performed (No in step S2), the controller 7 next determines whether the second switch 105b has been switched on (step S4).

If it is determined that the second switch 105b has not been switched on (No in step S4), the controller 7 executes the first creep mode (step S5). Accordingly, the electric motor 2 is rotated at the first rotational speed to output the creep torque. In other words, if it is determined that the acceleration operation has not been performed and the first switch 105a has been turned on, the controller 7 controls the electric motor 2 such that the electric motor 2 is rotated at the first rotational speed to output the creep torque.

If it is determined that the second switch 105b has been switched on (Yes in step S4), the controller 7 next determines whether at least either the temperature of the electric motor 2 or that of the hydraulic fluid in the torque converter 3 is less than or equal to the threshold (step S6). If it is determined that the temperature is greater than the threshold, in other words, if it is determined that the temperature is not less than or equal to the threshold (No in step S6), the controller 7 executes the processing in step S5. In other words, the controller 7 executes the first creep mode.

On the other hand, if it is determined that the temperature is less than or equal to the threshold (Yes in step S6), the controller 7 executes the second creep mode (step S7). Accordingly, the electric motor 2 is rotated at the second rotational speed to output the creep torque. In other words, if it is determined that the acceleration operation has not been performed, the first switch 105a has been turned on, and the second switch 105b has been switched on, the controller 7 controls the electric motor 2 such that the electric motor 2 is rotated at the second rotational speed to output the creep torque.

### [Modifications]

One preferred embodiment of the present invention has been explained above. However, the present invention is not limited to the above, and a variety of changes can be made without departing from the gist of the present invention. It should be noted that basically speaking, respective modifications to be described are applicable simultaneously.

(a) In the preferred embodiment described above, the shift lever is exemplified as the first switch 105a; however, the first switch 105a may be made in the form of other than the shift lever. For example, the first switch 105a may be a pushbutton switch or so forth.

(b) The drive unit 100 may not include the second switch 105b. In this case, the controller 7 executes only the first creep mode without executing the second creep mode.

(c) When at least either the temperature of the electric motor 2 or that of the hydraulic fluid is greater than the threshold, the controller 7 may control the electric motor 2 such that the electric motor 2 is rotated at a rotational speed lower than the first rotational speed to output the creep torque.

### LIST OF REFERENCE NUMERALS

2: Electric motor, 3: Torque converter, 7: Controller, 100: Drive unit, 105a: First switch, 105b: Second switch

1. A drive unit comprising:
an electric motor functioning as a drive source;
a torque converter configured to amplify a torque outputted from the electric motor; and
a controller controlling the electric motor such that the electric motor is rotated at a constant rotational speed to output a creep torque.

2. The drive unit according to claim 1, further comprising:
a first switch operable by a driver, wherein
the controller controls the electric motor such that the electric motor is rotated at a first rotational speed to output the creep torque when an acceleration operation has not been performed and the first switch has been turned on.

3. The drive unit according to claim 2, wherein the first rotational speed is set such that a first torque is less than or equal to a rated torque of the electric motor, the first torque calculated based on a capacity coefficient of the torque converter and the first rotational speed.

4. The drive unit according to claim 2, wherein the first rotational speed is less than or equal to a base rotational speed of the electric motor.

5. The drive unit according to claim 2, further comprising:
a second switch operable by the driver, wherein
the controller controls the electric motor such that the electric motor is rotated at a second rotational speed to output the creep torque when the acceleration operation has not been performed, the first switch has been turned on, and the second switch has been turned on.

6. The drive unit according to claim 5, wherein the second rotational speed is higher than the first rotational speed.

7. The drive unit according to claim 5, wherein the second rotational speed is set such that a second torque is greater than or equal to a rated torque of the electric motor and less than or equal to a maximum torque of the electric motor, the second torque calculated based on a capacity coefficient of the torque converter and the second rotational speed.

8. The drive unit according to claim 5, wherein the second rotational speed is less than or equal to a base rotational speed of the electric motor.

9. The drive unit according to claim 5, wherein the controller controls the electric motor such that the electric motor is rotated at the first rotational speed or less when at least either a temperature of the electric motor or a temperature of a hydraulic fluid in the torque converter is greater than a threshold after determining that the acceleration operation has not been performed, the first switch has been turned on, and the second switch has been turned on.

10. The drive unit according to claim 1, wherein the electric motor is the only drive source of the drive unit.
